(19) United States
(12) Patent Application Publication
(10) Pub. No.: US 2005/0148255 A1
(43) Pub. Date: Jul. 7, 2005

(54) Platinum metal based article for high temperature applications

(76) Inventor: Mark Laurence Doyle, Herts (GB)

Correspondence Address: RATNERPRESTIA, P O BOX 980, VALLEY FORGE, PA, 19482-0980, US

(21) Appl. No.: 10/501,642

(22) PCT Filed: Jan. 10, 2003
(86) PCT No.: PCT/GB03/00068

(30) Foreign Application Priority Data
Jan. 15, 2002 (GB) 0200758.1

(51) Int. Cl. D03D 15/00; D04B 1/16; B32B 15/14

(52) U.S. Cl. 442/185; 442/228; 442/229; 442/316; 428/608; 428/670

(57) ABSTRACT

A high temperature article, such as for use in a device such as a stirrer suitable for containing molten glass, has a base metal component (1), a knitted Pt Gauze layer (2), and an outer Pt cladding (3). The device exhibits resistance to attack by molten glass and resistance to interdiffusion between the Pt cladding and the base metal. Preferably a knitted or woven Pt or Pt alloy fabric is used as a diffusion limiting layer between the base metal pan and the other Pt cladding or protective layer.

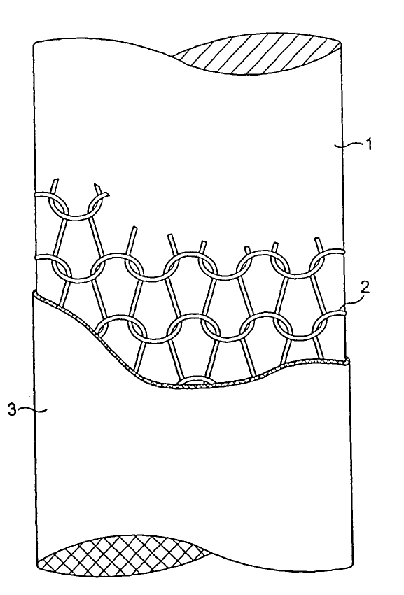

This invention concerns high temperature device and articles, meaning especially devices and articles used at molten glass temperatures, and which need to be protected from attack by molten glass.

In the glass industry, homogenising and gobbing stirrers are used. These parts require excellent high temperature strength at glass forming temperatures, which are generally in the range 1000 to 1250° C. The traditional material chosen for such parts is molybdenum (Mo) which is clad in platinum foil. Although Mo is resistant to molten glass, it is rapidly oxidised and volatilised in contact with air at temperatures above 700° C. To avoid oxidation, the Pt cladding must completely contain the Mo core and the space between the Pt cladding and the Mo part is evacuated to remove any oxygen. However, any direct contact between the Mo core and Pt cladding at elevated temperatures allows rapid inter-diffusion, so that the protection offered by the Pt cladding is compromised over time. It is therefore conventional to provide a protective coating on the Mo part, such as a sprayed ceramic, to act as a diffusion barrier. Such a multi-step construction adds complication and cost.

In recent years, oxide dispersion strengthened (“ODS”) alloys have become available (examples include PM1000, PM2000, MA758, MA956) with adequate high temperature strengths to act as stirrer cores for use in molten glass. Unlike Mo, these ODS materials do not catastrophically oxidise, but form relatively protective surface oxide layers. However, these ODS materials are not resistant to molten glass and therefore still require protection in the form of Pt cladding. The Pt cladding does not have to be a complete containment because of the greater resistance of the core material to oxidation. Interdiffusion remains a problem if the Pt and ODS materials are in direct contact. Unfortunately, the best types of ceramic interlayers which could be considered as a diffusion barriers, do not have expansion coefficients which match the requirements of the ODS alloys. Accordingly, these diffusion barrier layers can become damaged and spall off in service. In particular, the possibility of using part claddings (an opportunity to reduce cost) requires that the diffusion barrier layer extend right up to (or just beyond) the free edge of the cladding. This is a vulnerable point because if spalling of the interlayer did occur it could cause contamination of the glass.

There remains a need for a protected article which does not suffer significant interdiffusion yet retains adequate strength in a glass furnace. It is also an advantage if the interlayer is flexible under the conditions of operation such that it does not crack, crumble or spall.

Accordingly, the present invention provides a high temperature article comprising a base metal part and a platinum group metal (“PGM”) protective layer, separated by a diffusion limiting layer, characterised in that the diffusion limiting layer is a foraminate PGM structure.

Desirably, the foraminate PGM structure is a relatively low-density fabric, including woven or knitted fabrics, felts and sintered non-woven fabrics. It should be understood that other structures are included within the broadest scope of the invention. These may be highly expanded PGM sheet, PGM sheets with impressed “pimples”, and others. However, the presently preferred structure is a knitted PGM fabric. We refer to Johnson Matthey U.S. Pat. No. 5,266,293 which discloses the manufacture of such knitted fabrics as catalyst gauzes, especially for ammonia oxidation. Such knitted PGM fabrics are commercially available.

The PGM protective layer is preferably Pt or a Pt alloy. The foraminate PGM structure is preferably Pt or a Pt alloy. The preferred non-woven structures are made from thread or wire of approximately 50-85 μm diameter or from ribbon.

Preferred PGM structures have open areas of 60% or more and densities in the range 250-1200 g/m². This permits air circulation, which has benefits with ODS materials in maintaining stable, protective oxide layers and also limits points of direct PGM-base metal contact. Knitted structures have additional advantages including flexibility, so that they can readily conform to the shape of the underlying part, which may be a stirrer with a complex external screw. A knitted PGM fabric has minimal contact points so that any diffusion has to be through the contact points and multiple thin wires or ribbon, thus reducing diffusion of species from the PGM protective layer to the base metal part and vice versa.

A preferred base metal part is made from ODS material such as that marketed as PM2000 (Plansee Metals Ltd).

The invention will now be described by way of example and with reference to the accompanying schematic drawing.

A PM2000 ODS part, 1, has a knitted Pt-5% Rh gauze (JM ‘Nitrolok’), 2, applied thereto and fixed in place by hammer welding. Gauze 2 is knitted on a commercial knitting machine from 76 μm Pt—Rh wire to a weight of 620 g/m² Fitted over the Pt gauze is a Pt cladding 3, constructed from 1 mm thick Pt sheet by traditional methods.

A test article according to the invention has been tested in contact with molten glass for 1500 hours without failure or evidence of appreciable interdiffusion.

The skilled person will be able to modify and optimise the invention without departing from its scope.

1. A high temperature article comprising a base metal part and a platinum group metal (“PGM”) protective layer, separated by a diffusion limiting layer, wherein the diffusion limiting layer is a foraminate PGM structure.

2. An article according to claim 1, wherein the foraminate PGM structure is a fabric made from wire.

3. An article according to claim 1, where both the PGM protective layer and the foraminate PGM structure are Pt.

4. An article according to claim 3, wherein the foraminate PGM structure is a layer of knitted Pt wire.

5. An article according to claim 1, wherein the base metal part is formed from an ODS material selected from the group consisting of
20 Cr, 3 Fe, 0.5 Ti, 0.3 Al, 0.6 Y₂O₃, remainder Ni (by weight %),
20 Cr, 5.5 Al, 0.5 Ti, 0.5 Y₂O₃, remainder Fe (by weight %),
30 Cr, 0.6 Y₂O₃, 0.5 W, 0.37 Total O, 0.3 Al, 0.05 C, remainder Ni (by weight %), and
20 Cr, 4.5 Al, 0.5 Ti, 0.50 Y₂O₃, 0.045 N, 0.01 C, remainder Fe (by weight %).

6. An article according to claim 1, in the form of a homogenising or gobbing stirrer or other metallic part for use in a glass furnace.

7. An article according to claim 1, wherein the foraminate PGM structure is a fabric made from ribbon.

8. An article according to claim 1, where both the PGM protective layer and the foraminate PGM structure are a Pt alloy.

9. An article according to claim 3, wherein the foraminate PGM structure is a layer of woven Pt wire.

10. An article according to claim 3, wherein the foraminate PGM structure is a layer of knitted ribbon.

11. An article according to claim 3, wherein the foraminate PGM structure is a layer of woven ribbon.

12. An article according to claim 8, wherein the foraminate PGM structure is a layer of knitted Pt wire.

13. An article according to claim 8, wherein the foraminate PGM structure is a layer of woven Pt wire.

14. An article according to claim 8, wherein the foraminate PGM structure is a layer of knitted ribbon.

15. An article according to claim 8, wherein the foraminate PGM structure is a layer of woven ribbon.
